(19) United States
(12) Patent Application Publication
(10) Pub. No.: US 2020/0013097 A1
(43) Pub. Date: Jan. 9, 2020

(54) Connectivity Hub with Data-Hiding Features

(71) Applicant: DealerPolicy, Inc., Williston, VT (US)

(72) Inventors: Travis M. Fitzgerald, Colchester, VT (US); Jeffrey Mongeon, Colchester, VT (US); Michael John Burgiss, Marietta, GA (US); Weili Yuh, Needham, MA (US); Ryan Fitzgerald, Williston, VT (US)

(21) Appl. No.: 16/574,623

(22) Filed: Sep. 18, 2019

Related U.S. Application Data
(63) Continuation-in-part of application No. 15/142,387, filed on Apr. 29, 2016.
(60) Provisional application No. 62/734,467, filed on Sep. 21, 2018.
(60) Provisional application No. 62/795,754, filed on Jan. 23, 2019.
(60) Provisional application No. 62/822,681, filed on Mar. 22, 2019.
(60) Provisional application No. 62/155,914, filed on May 1, 2015.

(51) Int. Cl. G06Q 30/02; G06F 21/62; G06Q 40/08

(52) U.S. Cl. CPC G06Q 30/0283; G06Q 40/08; G06F 21/6245

(57) ABSTRACT

A connectivity hub server facilitates interactions between processors associated with multiple entities participating in the purchase and sale of goods and related coverage services. Minimal customer data is input through a customer client device and is used to retrieve additional customer data from one or more third-party data sources. Received customer data is analyzed to determine a level of sensitivity, and data items having a sensitivity level exceeding a threshold are obscured on the display of a dealer processor. The connectivity hub server queries one or more coverage provider processors and provides for display on the customer client device available coverage options received from a subset of the queried processors. Responsive to the customer selecting an available coverage option, the connectivity hub server opens a direct communication channel between the customer and selected coverage provider.

### CROSS REFERENCE TO RELATED APPLICATIONS

This application claims the benefit of U.S. Provisional Application No. 62/734,467, filed Sep. 21, 2018, U.S. Provisional Application No. 62/795,754, filed Jan. 23, 2019, and U.S. Provisional Application No. 62/822,681, filed Mar. 22, 2019, all which are incorporated by reference in their entirety.

This application is a continuation-in-part of co-pending U.S. application Ser. No. 15/142,387, filed Apr. 29, 2016, which claims priority to U.S. Provisional Application No. 62/155,914, filed May 1, 2015, both of which are incorporated by reference in their entirety.

### BACKGROUND

### 1. Technical Field

The subject matter described generally relates to a coverage selection system, and in particular, to a system architecture including a connectivity hub with data-hiding features.

### 2. Background Information

Current computing systems used in providing coverage protection, e.g., insurance protection for goods and services in need of same, as examples automobile insurance, renter's insurance, RV insurance, etc., are configured so that a dealer and a customer may confer and input customer information to a licensed and regulated (in many states) insurance broker (agent), e.g., online through a website for the broker (agent). The insurance agency sales and management software platform, e.g., “Vertafore 1™” can provide, e.g., carrier annual premiums. Once a “bindable” quote is received, the customer then decides whether to purchase the coverage. If so, then the broker/agent can provide the policy documents, e.g., by email, for the customer to sign and return. The dealer has to fax or email back the policy documents to the agency.

Additionally, conventional systems require a consumer purchasing a vehicle or other good to manually complete one or more applications, such as financing or credit applications, that collect sensitive data about the consumer, such as the consumer's employment and income information, residence information, Social Security number, and the like. Handwritten completion of these applications, in turn, requires personnel such as dealer employees or other retailers to manually enter the consumer's data into computer software applications typically used by dealer to complete the transaction. Such systems risk exposure of sensitive consumer data to malicious parties and increases the likelihood of erroneous data entry. Further, in instances where the consumer is also interested in obtaining insurance for the purchased vehicle or good, it is inefficient for the dealer to manually enter the consumer information into a quoting application and bridge the consumer data from a comparative rating environment to disparate websites of providers to accept payment and bind coverage.

### SUMMARY

A connectivity hub facilitates connections and interactions between processors associated with multiple entities participating in the purchase and sale of goods and related coverage services. In one embodiment, a customer seeking coverage interacts, through a customer client device or a dealer terminal, with a connectivity hub server and a coverage provider processor of a selected coverage provider to review available coverage options and bind coverage for a selected option. In the embodiments described herein, the dealer is a vehicle dealer, however, in other applications, the dealer is another type of vendor or retailer of other goods or services.

The connectivity hub server receives customer data through a dealer client device associated with a dealer from whom the customer is purchasing a vehicle or other good and queries one or more third-party data sources for additional customer data used by the modules of the connectivity hub server to validate the customer's identity and to obtain rates and terms for one or more available coverage options from a plurality of coverage provider processors. In some embodiments, the connectivity hub server analyzes the customer data received from the third-party data source and, responsive to determining that one or more data items exceed a threshold level of data sensitivity, obscures the sensitive data on the display of the dealer client device.

A subset of the queried coverage provider processors return to the connectivity hub server initial coverage options generated based on the received customer data. The connectivity hub server provides the initial coverage options for display on the customer client device, and, responsive to receiving customer input indicating an interest in one or more of the initial coverage options, queries the customer client device and/or the third-party data sources for additional customer data associated with a request for updated coverage options. The connectivity hub server sends the additional customer data to the coverage provider processors associated with the coverage options in which the customer indicated an interest, and a subset of the coverage provider processors return updated coverage options generated based on the additional customer data. Responsive to the customer selecting an updated coverage option, the connectivity hub server generates a direct connection between the customer client device and a coverage provider agent device associated with a selected coverage provider and performs API-based purchase processing and document generation for the selected coverage option.

In some embodiments, the connectivity hub server further performs a price-matching analysis to determine whether the customer qualifies for a price-matching offer. For example, the connectivity hub server accesses estimates for a first type of coverage sought by the user (e.g., auto insurance) and queries one or more third-party data sources for current coverage data for a second type of coverage (e.g., homeowner's insurance) used by the customer. Responsive to receiving the requested coverage data, the connectivity hub server uses an underwriting algorithm to determine customer eligibility for price-matching. If the connectivity hub server determines that the calculated customer risk is below or at a threshold risk level, a price-match offer is generated and provided for display on the customer client device.

### BRIEF DESCRIPTION OF THE DRAWINGS

FIG. 1 is a block diagram illustrating a networked computing environment, according to one embodiment.

FIG. 2 is a block diagram illustrating subsystems of a connectivity hub server, according to one embodiment.

FIG. 3 is a flow chart illustrating a coverage selection and communication channel generation process, according to one embodiment.

FIGS. 4A and 4B provide a flow chart illustrating a data-hiding and coverage selection process, according to an embodiment.

FIG. 5 is a flow chart illustrating a price-matching process, according to one embodiment.

FIG. 6 is a is a subsystem diagram illustrating components of the connectivity hub server 105 and interactions between the components, according to one embodiment.

FIG. 7 is a block diagram illustrating an example of a computer suitable for use in the networked computing environment of FIG. 1, according to one embodiment.

### DETAILED DESCRIPTION

The Figures (FIGS.) and the following description describe certain embodiments by way of illustration only. One skilled in the art will readily recognize from the following description that alternative embodiments of the structures and methods may be employed without departing from the principles described. Reference will now be made to several embodiments, examples of which are illustrated in the accompanying figures. It is noted that wherever practicable similar or like reference numbers are used in the figures to indicate similar or like functionality.

### Example Coverage Selection System

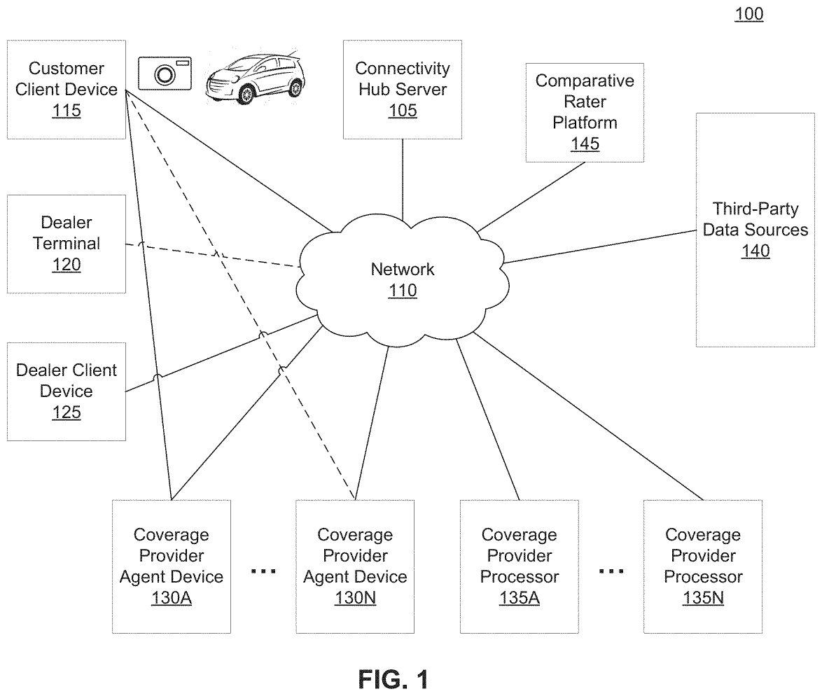

FIG. 1 illustrates one embodiment of a networked computing environment 100 that facilitates connections between processors associated with client devices, coverage provides, dealers, and third-party data sources to select and bind coverage services. In the embodiment shown in FIG. 1, the networked computing environment 100 includes a connectivity hub server 105 in communication through a network 110 with a customer client device 115, a dealer terminal 120, a dealer client device 125, one or more coverage provider agent devices 130A-N, one or more coverage provider processors 135A-N, one or more third party data sources 140, and a comparative rater platform 145. In other embodiments, the networked computing environment 100 contains different and/or additional elements. In addition, the functions may be distributed among the elements in a different manner than described.

FIG. 1 uses like reference numerals to identify like elements. A letter after a reference numeral, such as “130A,” indicates that the text refers specifically to the element having that particular reference numeral. A reference numeral in the text without a following letter, such as “130,” refers to any or all of the elements in the figures bearing that reference numeral. For example, “130” in the text references to the reference numerals “130A” and “130N” in the figures.

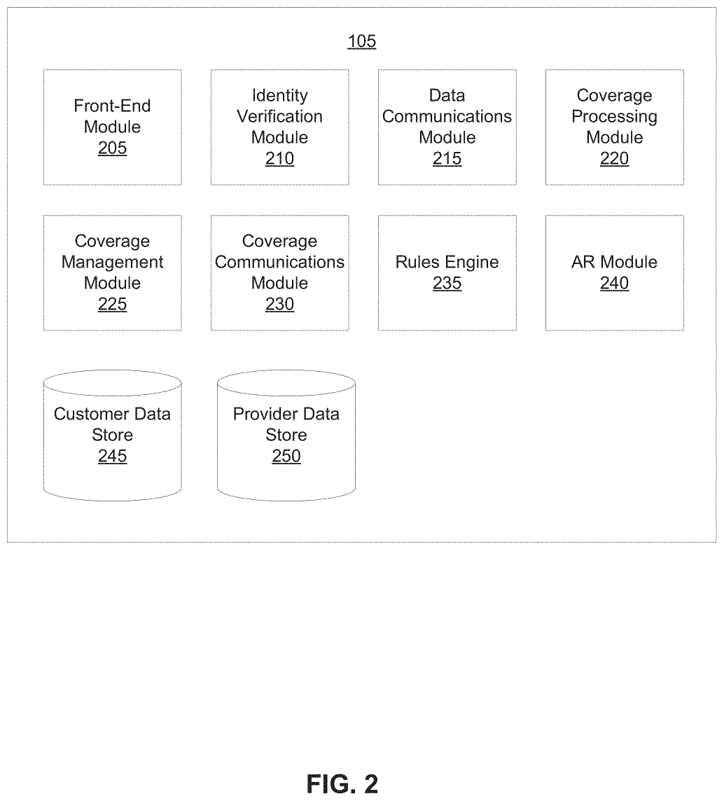

The connectivity hub server 105 provides a platform that allows customer, dealer, and coverage provider users to interact to select from available coverage options and bind coverage between the customer and a selected provider. In various embodiments, the modules of the connectivity hub server 105 enable these interactions by obtaining customer data from the customer and from third-party data sources 140, sending the customer data to a plurality of coverage provider processors 135, receiving, from a subset of the coverage provider processors 135, coverage information for available coverage options, and opening a direct communication channel between a customer client device 115 and a selected coverage provider agent device 130A. The connectivity hub server 105 further ensures the privacy of sensitive customer data by obscuring data received from third-party data sources 140 from dealer users of the networked computing environment 100. Various embodiments of the connectivity hub server 105 are described in greater detail below, with reference to FIG. 2.

The network 110 comprises any combination of local area and/or wide area networks, using both wired and/or wireless communication systems. In one embodiment, the network 110 uses standard communications technologies and/or protocols. For example, the network 110 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 110 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 110 may be represented using any suitable format, such as hypertext markup language (HTML) or extensible markup language (XML). Those skilled in the art will recognize that encryption using other suitable techniques will be appropriate for various applications based on the nature of the network 110.

The customer client device 115, the dealer terminal 120, the dealer client device 125, and the one or more coverage provider agent devices 130A-N are computing devices capable of receiving user input as well as transmitting and/or receiving data via the network 110. In one embodiment, the devices 115, 120, 125, and 130 are conventional computer systems, such as a desktop or laptop computer. Alternatively, the devices 115, 120, 125, and 130 are devices having computer functionality, such as a mobile telephone, a smartphone, a set-top box, a smart home device, or another suitable device. The devices 115, 120, 125, and 130 further include a camera capable of capturing images and videos, an input/output (I/O) component to transfer data to, and receive data from, other entities in the networked computing environment 100, and a storage unit to store, for example, coverage documents for a selected policy.

In various embodiments, each of the devices 115, 120, 125, and 130 connect through the network 110 to the connectivity hub server 105 and/or directly (e.g., using a peer-to-peer protocol) to one or more other devices 115, 120, 125, and 130 in the networked computing environment 100. For example, in one embodiment, the customer client device 115 connects through the network 110 to the connectivity hub server 105 to input customer data and obtain information regarding available coverage options. Alternatively, the customer interacts with the connectivity hub server 105 through the dealer terminal 120.

Each coverage provider processor 135 is associated with one or more coverage provider agent devices 130 through which customers interact with a selected coverage provider. The coverage provider processor 135 receives requests from the customer through the customer client device 115 or the dealer terminal 120 for policy coverage options and generates rates based on customer data received through the connectivity hub server 105. Responsive to the customer selecting an available coverage option, the coverage provider processor 135A of the selected provider establishes a direct connection with the customer client device 115 or the dealer terminal 120 (e.g., to bind and purchase coverage, as discussed below with respect to FIG. 2).

The environment 100 of FIG. 1 also includes one or more third-party data sources 140 that store customer data used by the connectivity hub server 105 to facilitate the generation and selection of coverage options. In one embodiment, the third-party data sources 140 include one or more coverage providers, such as the coverage providers associated with the coverage provider processors 135. Data received from the third-party data sources 140 is used, for example, to prefill customer applications for insurance coverage, thus improving the efficiency and accuracy of the coverage selection process by reducing the amount of customer data entered manually by the customer or dealer. Additionally, in some embodiments, the third-party data sources 140 identify a level of sensitivity of customer data when returning the requested data to the connectivity hub server 105. Responsive to determining that the level of sensitivity of received data exceeds a threshold, the connectivity hub server 105 obscures portions of the data from the dealer and, optionally, displays on the dealer client device 125 an indication that the data collection has been completed. In this way, the connectivity hub server 105 reduces the amount of sensitive customer data displayed to the dealer and decreases the likelihood of malicious data usage. Received customer data is further used, in some embodiments, by the connectivity hub server 105 to verify the accuracy of customer data manually input through the customer client device 115.

In various embodiments, customer data provided by the third-party data sources 140 to the connectivity hub server 105 includes personally identifiable information (PII) about the customer. Customer data further includes, in various implementations, demographic data, vehicle driving record violations and incidents, vehicles/equipment currently in possession of the customer and related liens and leases, current insurance coverage types and amounts and associated carrier(s), and insurance claim history for a customer and the customer's household members and property.

The comparative rater platform 145 generates available coverage options and rates for a requesting customer based on received customer data. In one embodiment, the comparative rater platform 145 uses direct API access to one or more coverage provider processors 135 to obtain and aggregate coverage option and rate data. The aggregated data is stored and used to generate coverage options for a customer without requiring the modules of the connectivity hub server 105 to query the coverage provider processors 135 directly. The connectivity hub server 105 thus queries the comparative rater platform 145 with a completed coverage application for a requesting customer, and the comparative rater platform 145 returns initial coverage options and rates based on the stored coverage provider data and the received coverage application. In some embodiments, the connectivity hub server 105 performs risk filtering before sending the customer application to the comparative rater platform. For example, in some implementations, the connectivity hub server 105 uses machine learning to predict, for new customers, which coverage provider the customer might select, how long the customer might remain with the selected coverage provider, etc. Additionally, while the displayed embodiment shows the comparative rater platform 145 as a third-party platform connected through the network 110 to the connectivity hub server 105, in other embodiments, the comparative rater platform is a module on the connectivity hub server 105.

### Example Connectivity Hub Server Subsystems

FIG. 2 is a block diagram of an architecture of the connectivity hub server 105. The connectivity hub server 105 shown in FIG. 2 includes a front-end module 205, an identity verification module 210, a data communications module 215, a coverage processing module 220, a coverage management module 225, a coverage communications module 230, a rules engine 235, an AR module 240, a customer data store 245, and a provider data store 250. In other embodiments, the connectivity hub server 105 includes additional, fewer, or different components for various applications. Conventional components such as network interfaces, security functions, load balancers, failover servers, management and network operations consoles, and the like are not shown so as not to obscure the details of the system architecture.

The front-end module 205 facilitates communication between the connectivity hub server 105 and the customer client device 115, the dealer terminal 120, the dealer client device 125, the coverage provider agent devices 130, the coverage provider processors 135, and the third-party data sources 140. In one embodiment, third-party data sources 140 interact with the connectivity hub server 105 through the front-end module 205 to provide requested customer data. Coverage provider processors 135 also interact with the connectivity hub server 105 through the front-end module 205 to provide coverage options based on the received customer data. Similarly, the customer client device 115 submits requests for coverage options and input customer data to the connectivity hub server 105 through the front-end module 205. For example, in one embodiment, customer data input through the front-end module 205 includes basic customer information, such as the customer's name, address, date of birth, driver's license number, phone number, email address, marital status, residence type, gender; other pertinent information, such as information concerning the vehicle or other good being purchased, accidents, violations, or losses associated with the customer during a specified time period; information about the customer's current coverage, such as the customer's current insurance company(ies), premium(s), whether the customer is eligible for policy discounts; and related permissions, including permission for the connectivity hub server 105 to query one or more third-party data sources 140 to obtain additional data about the customer, such as the customer's current insurance score. In other embodiments, the front-end module 205 prompts the customer to enter minimal PII, such as the customer's phone number, the zip code of the customer's primary residence, and/or the customer's date of birth. The front-end module 205 transmits the received customer data to the identity verification module 210, which verifies the customer's identity, as discussed below.

In some embodiments, the front-end module 205 further uses machine learning to determine which third-party data source(s) 140 to query to obtain additional data about the customer. For example, the amount and type of data stored by each of the third-party data sources 140 for users of the connectivity hub server 105 may vary based on, e.g., whether the user is a user of the third-party data source 140 or whether the type of data stored by the third-party data source 140 is relevant to the request for coverage. In some embodiments, input to a machine learning model includes one or more items of customer profile data, including the customer's likelihood of purchasing coverage, how many vehicles and drivers are in the customer's household, an expected closing ratio, and the like. The model outputs an indication of one or more third-party data sources 140 to query for additional customer data.

The front-end module 205 further queries the customer client device 115 to obtain user consent to sharing the collected user data with one or more third-party data sources 140 and one or more coverage provider processors 135. For example, in one embodiment, the connectivity hub server 105 transmits minimal PII about the customer to one or more third-party data sources 140 to obtain additional information about the customer that may be used, for instance, to prefill a customer application for insurance coverage. In another example, customer data obtained from user input (via the customer client device 115, the dealer terminal 120, and/or the dealer client device 125) and/or from third-party data sources 140 is transmitted to one or more coverage provider processors 135, of which a subset of the coverage provider processors 135 return available coverage options based on the transmitted customer data. Responsive to the connectivity hub server 105 receiving the available coverage options, the front-end module 205 provides the coverage options for display on the customer client device 115.

The identity verification module 210 verifies the customer's identity based on the customer data received through the customer client device 115. For example, in one embodiment, a user of the dealer client device 125 inputs a phone number of a customer through the front-end module 205. Responsive to receiving the phone number, the identity verification module 210 sends a message (e.g., via SMS, text, email, or the like) to the customer client device 115 associated with the phone number. Selection of an address (e.g., HTTP, URL, or other network address) in the message connects the customer client device 115 to the front-end module 205, which prompts the customer to enter one or more items of PII, such as the customer's zip code of primary residence and date of birth. The identity verification module 210 compares the received PII with data received from one or more third-party data sources 140 that store information, including unique identifying information, describing the ownership and use relationships between users and associated devices and verifies the customer identity based on the compared data (i.e., based on the received PII matching the client device 115 from which the PII was sent). For example, in one embodiment, the identity verification module 210 combines the PII with one or more unique network interface device address/identification numbers (e.g., a SIM card, EMIEA number, or the like) to locate a subscriber record in a consumer information database connected to the connectivity hub server 105 and appends the subscriber data record to the PII received from the customer client device 115.

The data communications module 215 interfaces with the third-party data sources 140 to obtain additional data about the customer. Third-party data sources 140 typically provide data in various formats that are not all consistent with any particular standard or with one another. Data communications module 215 accordingly provides, for each of such data sources 140, a mechanism for properly communicating with such source.

In one embodiment, the data communications module 215 uses a carrier onboarding tool (not shown) with a rules engine to determine the coverage provider processors 135 to which to send customer data. Customer data is gathered from a variety of sources, including via data entry through the customer client device 115 or the dealer terminal 120 and one or more third-party data sources 140 who provide marketing data, public data, court-based records, and other customer data that the customer has consented to sharing for purposes of the coverage binding process. Based on customer data such as household composition, driver class, driving history, and insurance status, the carrier onboarding tool interacts with a machine learning trained predictive model to predict the most appropriate coverage provider(s) for receiving the customer data.

In one embodiment, the data communications module 215 provides direct API access to the connectivity hub server 105 to a coverage provider processor 135 to allow the coverage provider to control and customize a user interface of the connectivity hub server 105.

The coverage processing module 220 aggregates the additional customer data received from the third-party data sources 140 and prefills one or more fields of an application for coverage using at least the customer data received through the customer client device 115 and the additional customer data. In some embodiments, the coverage processing module 220 provides the additional customer data for display on the customer client device 115 to allow the customer to verify the accuracy of the received data. The prefilled application is similarly provided to the customer for approval before the coverage processing module 220 submits the completed application to the one or more coverage provider processors 135. Additionally, if the coverage processing module 220 determines that the customer data received from the third-party data sources 140 does not include data responsive to one or more fields of the application, the coverage processing module 220 queries the customer to provide the missing data. The customer is further queried, in some embodiments, to answer one or more provider-specific questions based on the product line for which the customer seeks coverage (e.g., auto, home, umbrella, etc.).

In some embodiments, the coverage processing module 220 sets one or more terms of the application to a default amount, such as a default limit of liability (e.g., 100,000/300,000/500,000) and/or the choice of full coverage (e.g., comprehensive and collision coverage with a $500 deductible) such that the customer client device 115, the dealer terminal 120, and/or the dealer client device 125 display interface elements informing the customer and/or the dealer user that the terms cannot be changed. The default terms are included in the application during the initial quoting process and may, in some implementations, be reviewed and adjusted during subsequent interactions between the customer and the selected coverage provider. After the customer selects an available coverage provider, the coverage processing module 220 facilitates the processing of the associated coverage option by generating documents such as applications, disclosures, identification cards, binders, and the like, and processing customer payment by displaying and accepting customer credit card and bank account information.

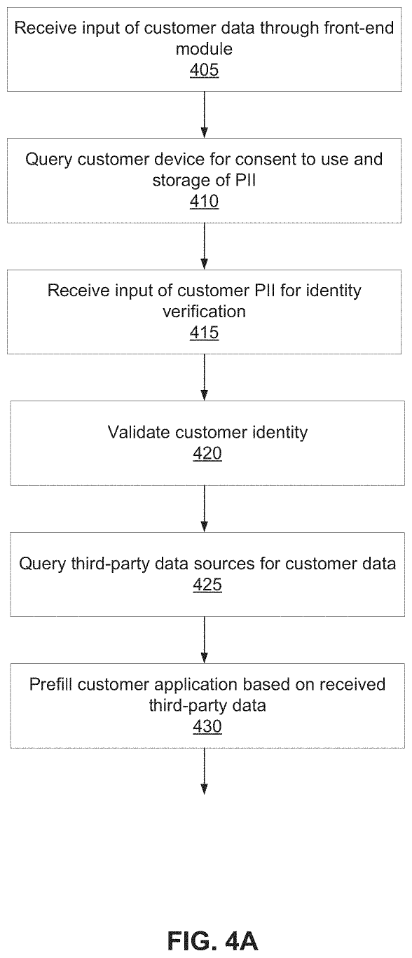

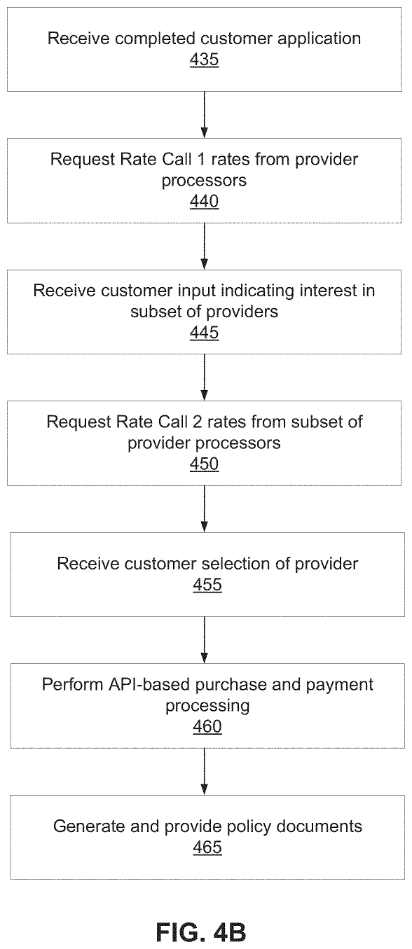

The coverage management module 225 queries each of a plurality of coverage provider processors 135 for available coverage options based on the generated application. In one embodiment, the data communications module 215 requests, from each coverage provider processor 135, a “rate call 1” rate, such that the rate is non-binding and is based on data provided by the customer (i.e., the accuracy of the customer-provided data is not verified by data from one or more third-party data sources 140). As discussed below with respect to FIG. 4, in some embodiments, the coverage management module 225 queries a subset of the coverage provider processors 135 for updated coverage options (i.e., “rate call 2” rates) responsive to receiving additional data about the customer from one or more third-party data sources 140. In another embodiment, the coverage management module 225 sends the completed application to the comparative rater platform 145, which returns one or more initial coverage options and rates based on the customer data and stored coverage data for the coverage provider processors 135.

In some embodiments, the coverage management module 225 optimizes profitability via machine learning by using a trained model to determine which of the received coverage options to provide for display to the customer. In various implementations, input to the trained model includes customer data such as household composition, driver class, driving history, insurance status and history, and data associated with the vehicle that the customer is purchasing. Input to the model further includes profitability data indicating the customer's likely retention rate, a commission rate, and the like. For example, if stored profile data for customer A indicates that the customer is likely to stay with a coverage provider for a long period of time, the model outputs an instruction to display to the customer only available coverage providers that have a higher lifetime expectancy.

In embodiments where additional customer data is provided to a dealer client device 125 and/or a dealer terminal 120 used by a dealer user (e.g., an employee of a dealership at which the customer is purchasing a vehicle), the coverage management module 225 obscures some or all of the received from the third-party data sources 140 on the display of the dealer client device 125 and/or dealer terminal 120. In some implementations, the coverage management module 225 analyzes the received customer data and determines whether one or more data items have at least a threshold level of sensitivity (e.g., the data includes the customer's credit card number, income information, PII, or the like). Responsive to determining that the sensitivity level for one or more data items exceeds the threshold, the coverage management module 225 obscures the data items such that the dealer user is not able to see the sensitive customer data. Rather, the coverage management module 225 provides for display on the dealer client device 125 and/or the dealer terminal 120 an indication that the data collection has been completed.

The coverage communications module 230 facilitates communication between the customer and a selected coverage provider by establishing a direct communication channel between the customer client device 115 and the coverage provider agent device 130A associated with the selected coverage provider processor 135A. In one embodiment, the customer selects a preferred method of communication with the selected coverage provider, such as instant messaging, video call, or telephone call. The coverage provider may prompt the customer to answer additional questions or provide additional information in accordance with the provider's policies or requirements. Additionally, in some embodiments, the coverage communications module 230 provides for display on the coverage provider agent device 130A an interface allowing the coverage provider to access the customer's completed application and/or additional data associated with the customer and stored in the customer data store 245, such as motor vehicle records and accident and claim history reports.

The direct connection generated by the coverage communications module 230 allows the customer and the coverage provider to communicate about available coverage options and select a policy that fits the customer's needs. The coverage provider provides a bindable quote to the customer and sends to the customer policy documentation associated with the selected coverage option. For example, in one embodiment, the coverage provider processor 135A sends the policy documentation directly to the customer client device 115 (e.g., via email). In other embodiments, the policy documentation is uploaded to the connectivity hub server 105 such that the customer client device 115 can access the documentation through the front-end module 205. In some implementations, the policy documentation includes one or more documents for execution by the customer. The customer accesses the documents, for example, by using a hyperlink provided by the coverage provider processor 135A and executes the documents using DocuSign or another means of electronic signature.

The rules engine 235 analyzes customer data to determine whether the customer qualifies for policy price-matching. In one embodiment, the rules engine 235 queries the customer for the customer's account information (e.g., ID and password) associated with a first type of coverage (e.g., homeowner's insurance coverage). The rules engine 235 uses the received account information to query one or more third-party data sources 140 (e.g., mortgage escrow companies, title companies, government agencies, provider databases, etc.) for information about the customer's current coverage such as the current policy provider, term, term limits, premium, insurance dwelling or property, coverage, limits, and deductibles. If the third-party data sources 140 do not return all of the requested customer data, the rules engine 235 queries the customer through the customer client device 115 to provide the requested data. For example, if the customer uploads a copy of a policy declaration through the front-end module 205, the rules engine 235 uses optical character recognition (OCR) on an image of the declaration page and analyzes the result of the OCR to determine the applicable coverage, limits, and deductibles.

Expense ratios, profit margins, rating factors, risk algorithms, and related data of available providers are aggregated and stored in a provider data store 250 on the connectivity hub server 105. Responsive to receiving the current coverage information for the customer, the rules engine 235 uses data retrieved from the provider data store 250 and the current coverage information to calculate a predicted loss cost for the customer under the customer's current policy. In one embodiment, the rules engine 235 adds the allocated expense load and profit margin to determine the desired price and compares the desired price and the pre-determined price to determine if the specific risk is acceptable (i.e., if the customer qualifies for price-matching). Alternatively, the rules engine 235 calculates the allowable gross profit margin and compares the desired gross profit margin and the allowable gross profit margin to determine if the specific risk is acceptable.

If the rules engine 235 determines that the customer qualifies for price-matching, the front-end module 205 provides for display information about the proposed coverage package and individual policy price and savings based on the price-match offer. Conversely, if the rules engine 235 determines that the customer does not qualify, the rules engine 235 identifies gaps in the customer's current coverage and alerts the customer, through the front-end module 205 to a possible exposure or coverage overage and prompts the customer to speak with an agent.

The AR module 240 identifies a vehicle or other good based on a captured image and generates one or more augmented reality elements associated with the vehicle and/or associated coverage option for display on the customer client device 115. For example, in one embodiment, a camera on the customer client device 115 captures an image of a vehicle and transmits the image to the AR module 240, which identifies in the image an alpha-numeric string or barcode of the vehicle's serial number or the Vehicle Identification Number (VIN). The AR module 240 references a third-party data source 140, such as a vehicle database, to obtain identifying information about the vehicle based on the alpha-numeric string, such as the year of manufacture, the make and model, and the like.

In some embodiments, the connectivity hub server 105 is connected to a geolocation server (not shown) that provides a current location of the customer client device 115. The AR module 240 combines the location data from the geolocation server with a database of address and geolocation data of records to determine where (i.e., which dealer location) the customer client device 115 is likely located when it captures the image of the vehicle.

Responsive to identifying the vehicle, the AR module 240 queries a database containing an aggregation of vehicle inventory available at or by a plurality of dealer locations for available vehicles having the year, make, and model of the inquiry. In some embodiments, the AR module 240 filters the received results to remove available vehicles with current locations outside a defined geographic region (e.g., vehicles that are not located on the dealer's lot). In this way, the AR module 240 limits the results of the aggregate inventory database to those vehicles that are located at the identified dealer.

If the AR module 240 determines that one or more matching vehicles are available on the dealer's lot, the AR module 240 generates one or more AR elements associated with the available vehicles. Example AR elements include graphical and/or textual elements identifying the available vehicle(s), for instance, by informing the customer how many of the vehicles are available on the dealer's lot, where the vehicles are located, etc. Additional displayed information includes, in some embodiments, a price of the vehicle and/or an estimated insurance quote. The generated AR elements are provided for display on the customer client device 115, such as by overlaying the elements on a video feed or an image of the vehicle.

Each user of the connectivity hub server 105 is associated with a customer profile, which is stored in the customer data store 245. A customer profile includes declarative information about the user that was explicitly shared by the user and also includes additional customer information received from the third-party data sources 140 and one or more coverage provider processors 135. In one embodiment, a customer profile includes multiple data fields, each describing one or more attributes of the corresponding customer. Examples of data stored in a customer profile include biographic information, employment and income information, credit information, payment information, current and past residences, contact information, mobile device carrier, and current and past insurance policies and individuals and property covered by the policies. In certain embodiments, the customer profile further includes policy documentation, such as completed applications and executed policy documents, as well as records of customer consent to allow the modules of the connectivity hub server 105 to access and use the customer data in the coverage selection process. Stored data about a customer is used, in some embodiments, to prefill applications or other documents such that the customer does not have to provide data previously submitted to the connectivity hub server 105. In such embodiments, the customer instead is prompted, through the front-end module 205, to validate or update the stored information.

### Example Coverage Selection and Communication Channel Generation Process

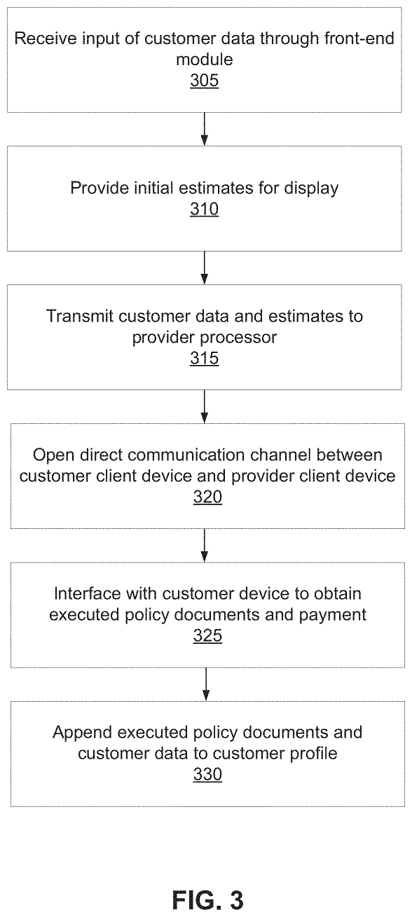

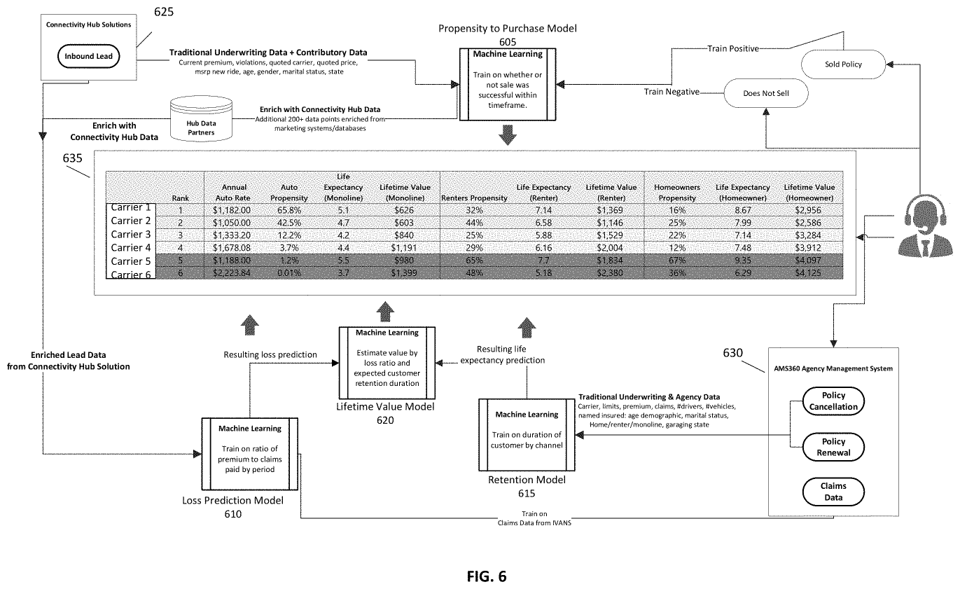

FIG. 3 illustrates a method for opening a direct communication channel between a customer client device 115 and a coverage provider agent device 130A of a selected coverage provider, according to an embodiment. The steps of FIG. 3 are illustrated from the perspective of the connectivity hub server 105 that performs the method 300. However, in various implementations, some or all of the steps are performed by other entities or components. In addition, some embodiments perform the steps in parallel, perform the steps in different orders, or perform different steps. In addition, the steps are embodied as instructions executable by a processor of a machine, for example, as described by FIG. 6.

At 305, customer information of a customer user of the connectivity hub server 105 is input to the connectivity hub server 105 through a front-end module 205. In one embodiment, the customer information is received from a customer client device 115 associated with the customer, while in other embodiments, the customer information is entered by the customer or a dealer user (e.g., an employee of a dealership from which the customer is purchasing a vehicle) through a dealer terminal 120. Examples of customer information entered through the front-end module 205 include PII such as the customer's name, date of birth, and address, as well as information about the vehicle or other good for which the customer is seeking coverage.

The front-end module 205 provides 310 for display on the customer client device 115 one or more initial coverage options based on the received customer data. In one embodiment, the initial coverage options, including, for example, the interest rates, terms, and quotes, are generated by the comparative rater platform 145. The initial coverage options and customer data are further transmitted 315 by the coverage management module 225 to a coverage provider processor 135 of a selected coverage provider. In various embodiments, the coverage provider is selected by the customer via input through the front-end module 205.

At 320, the customer chooses a preferred method of communication (e.g., video call, instant messaging, or phone call, or the like), and the coverage communications module 230 opens a direct communication channel between the customer client device 115 and a coverage provider agent device 130 using the preferred method. If the customer elects to purchase coverage from the provider using a “direct bind” option, the front-end module 205 prompts the customer to answer additional questions based on requirements associated with the selected provider. At 325, the front-end module 205 interfaces with the customer client device 115 to obtain executed policy documents and payment for the selected coverage option. The executed policy documents and received customer data are then appended 330 to the customer profile in the customer data store 245.

While the embodiment described in FIG. 3 opens a communication channel between the customer client device 115 and a device associated with a coverage provider processor 135 selected by the customer via the customer client device 115, in other embodiments, the coverage management module 230 sends, to each of a plurality of coverage provider processors 135, a portion of the customer data and receives, from a subset of the queried coverage provider processors 135, available coverage options and rates. The available coverage options and rates for the various coverage providers are provided for display on the customer client device 115, and the coverage communications module 230 opens the direct communication channel between the customer client device 115 and a coverage provider agent device 130A responsive to the customer selecting an available coverage provider or option.

### Example Data-Hiding and Coverage Selection Process

FIG. 4 illustrates a method for generating available coverage options and performing data hiding of one or more data fields containing sensitive customer data, according to an embodiment.

At 405, the front-end module 205 receives from a dealer client device 125 input of customer data associated with a customer seeking coverage services (e.g., insurance coverage for a vehicle). In one embodiment, the customer data includes a customer name, phone number, and information about the vehicle, such as the year, make, model, VIN, stock number, or the like. Responsive to receiving the customer phone number, the front-end module 205 queries 410 the customer client device 115 requesting consent to access, use, and store customer PII as part of the insurance quotation and binding process.

In some embodiments, customer PII is furthers used to verify the customer's identity. For example, the front-end module 205 receives 415 input from the customer client device 155 of minimal PII, such as the customer's zip code of primary residence and date of birth. The received PII is transmitted to the identity verification module 210, which verifies 420 the customer's identity by matching the received PII to the device from which the PII was sent. For example, the identity verification module 210 combines the received PII with one or more unique network interview device address or identification number(s) (e.g., SIM card, EMIEA number, etc.) assigned to the device to locate a subscriber record in a consumer information database connected to the connectivity hub server 105 and appends the subscriber record data to the received PII.

At 425, the data communications module 215 queries one or more third-party data sources 140 containing PII and additional customer information to append a plurality of additional PII, demographic, and other subscriber/prospective retail customer information required for or pertinent to the customer transaction (e.g., the purchase of a vehicle) and/or the customer request for coverage. Responsive to receiving the additional customer information, the coverage processing module 220 aggregates the received data and prefills 430 one or more fields of a coverage application associated with the requested coverage. The prefilled application is transmitted to the customer client device 115, and, optionally, the dealer client device 125, to allow the customer and dealer to review, edit, and/or complete the prefilled application prior to submission to one or more coverage provider processors 135. In one embodiment, some or all of the additional customer information received from the third-party data sources 140 is obscured on the dealer client device 125. For example, as discussed above with respect to FIG. 2, the coverage management module 225 analyzes the received customer data to determine whether one or more data items have at least a threshold level of sensitivity (e.g., the data includes the customer's credit card number or income information). Responsive to determining that the sensitivity level for one or more data items exceeds a threshold, the coverage management module 225 obscures the data item(s) on the dealer client device 125 such that the dealer is not able to see the sensitive customer data. The sensitive data, however, is provided for display on the customer client device 115 to allow the customer to view and, in some embodiments, edit the information.

The coverage processing module 220 receives 435 the application and transmits 440 the application to one or more coverage provider processors 135 with a request for initial (i.e., “rate call 1”) coverage options and rates. In one embodiment, initial coverage options and rates are returned from a subset of the queried coverage provider processors 135 and provided for display to the customer through the front-end module 205. Responsive to receiving 445 customer input indicating an interest in one or more of the initial coverage options, the coverage processing module 220 requests 450 updated coverage options (e.g., “rate call 2” rates) from the coverage provider processors 135 associated with the initial coverage options in which the customer indicated an interest. In one embodiment, the coverage processing module 220 prefills one or more additional data fields in the application before sending the request for updated coverage options to the coverage provider processors 135. For example, the coverage processing module 220 requests, from the one or more third-party data sources 140, additional customer data associated with the request for updated coverage options and/or queries the customer to provide additional customer data and/or answer one or more additional questions. In some embodiments, the additional prefilled application fields are provided for display to the customer client device 115 to allow the customer to review and approve the fields before submission of the updated application to the coverage provider processors 135.

Updated coverage options are received at the data communications module 215 from one or more of the coverage provider processors 135 and provided for display through the front-end module 205. Responsive to receiving 455 customer input indicating a selection of an updated coverage option or a coverage provider, the coverage communications module 230 generates a direct connection between the customer client device 115 and a coverage provider agent device 130A of a selected coverage provider. If the customer decides to purchase coverage from the selected coverage provider, the coverage processing module 220 performs 460 API-based purchase and payment processing with one or more third-party data sources 140, such as a lending platform, an insurance rating platform, a carrier platform, a payment platform, and a document platform. The coverage processing module 220 further generates and provides 465 policy documents associated with the selected coverage option. In one embodiment, the policy documents are sent by the coverage communications module 230 to the customer client device 115 for execution and executed policy documents are stored in the customer profile in the customer data store 245.

### Example Price-Matching Process

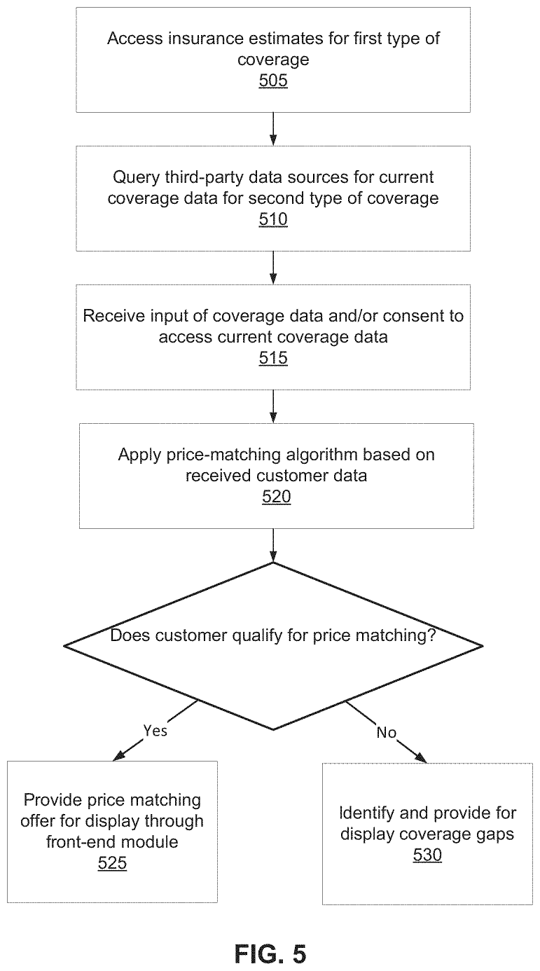

FIG. 5 illustrates a method for generating a price-match offer for a customer user of the connectivity hub server 105, according to an embodiment. In one embodiment, the price-match is for a related offering for which additional information is required to determining pricing and price-matching. For example, in one embodiment, the related offering is for homeowners insurance, while in other applications, the related offering is a related product or add-on purchase, such as a cargo trailer, or the like.

At 505, the rules engine 235 accesses coverage estimates for a first type of coverage sought by the user (e.g., auto insurance). As described above with respect to FIGS. 2-4, available coverage options are generated by one or more coverage provider processors 135 and/or by a comparative rater module on the connectivity hub server 105.

The rules engine 235 queries 510 one or more third-party data sources 140 for current coverage data for a second type of coverage used by the customer. For example, in one embodiment, the second type of coverage is homeowner's insurance, and the rules engine 235 queries the third-party data sources 140 for coverage data including the customer's current insurer, terms, term premium, insured dwellings, coverage, limits, deductibles, and the like. If the third-party data sources 140 do not return all of the requested data, the rules engine 235 queries the customer client device 115 for the additional coverage data and/or prompts the customer to consent to access the coverage data from one or more additional third-party data sources 140 not contacted in the previous query.

Responsive to receiving 515 the additional coverage data from the customer and/or the third-party data sources 140, the rules engine 235 applies 520 a price-matching or underwriting algorithm to determine whether the customer qualifies for price-matching for the second type of coverage.

If the rules engine 235 determines that the calculated customer risk is below or at a threshold risk level, the rules engine 235 generates the price-match offer and provides 525 the offer, including the individual policy price and the savings, to the customer through the front-end module 205. Conversely, if the calculated customer risk exceeds the threshold risk level, the rules engine 235 determines that the customer does not qualify for the price-match offer. In such an embodiment, however, the rules engine 235 analyzes the current coverage data for the second type of coverage to identify 530 one or more gaps. If one or more gaps are identified, the rules engine 235 alerts the customer through the front-end module 205 to a possible exposure or coverage overage and prompts the customer to speak with a coverage provider.

### Example Machine Learning Subsystem

FIG. 6 is a subsystem diagram illustrating components of the connectivity hub server 105 and interactions between the components, according to one embodiment. The embodiment displayed in FIG. 6 includes a propensity to purchase model 605, a loss prediction model 610, a retention model 615, a lifetime value model 620, a connectivity hub 625, an agency management system 630, and a customer coverage table 635.

In some implementations, the connectivity hub server 105 uses the models to predict coverage data for an incoming customer, such as the customer's propensity to purchase one or more types of coverage, a loss prediction for the customer, the customer's expected retention duration, and a lifetime value of the customer. For example, the connectivity hub 625 receives, through a customer client device 115 or a dealer terminal 120, data associated with a new customer seeking coverage from a coverage provider. The connectivity hub 625 provides as input to the propensity to purchase model 605 underwriting and contributory data associated with the customer, such as the customer's current premium, violations, quoted carrier, quoted price, a manufacturer's suggested retail price of a vehicle, as well as biographic information about the customer, such as the customer's age, gender, marital status, state of residence, and the like. In one embodiment, the connectivity hub server 105 queries one or more third-party data sources 140 for additional data about the customer and enriches the customer data with the additional data received from the third-party data sources 140 prior to inputting the data into the propensity to purchase model 605.

In one embodiment, the propensity to purchase model 605 is trained based on historical data associated with past coverage purchases. The connectivity hub server 105 receives from a dealer terminal 120 data indicating whether the dealer sold a coverage policy to a given customer. If the dealer sold a coverage policy to the customer, data indicating the sale and associated customer information is included in a positive training set of data used to train the propensity to purchase model 605. Conversely, if the dealer did not sell a coverage policy to a customer, data indicating the lack of a sale and associated customer information is included in a negative training set of data used to train the propensity to purchase model 605. The propensity to purchase model 605 is thus trained on whether a sale to a given customer was successful, and the trained model outputs, based on received customer data, an indication of whether the customer is likely to purchase coverage through the connectivity hub server 105.

The enriched customer data discussed above additionally serves as input to the loss prediction model 610. In one embodiment, the connectivity hub server 105 uses machine learning to train the loss prediction model 610 based on training data received from the agency management system 630. The training data includes ratios of coverage policy premiums to claims paid by the coverage provider. Once trained, the loss prediction model 610 outputs, for a given customer, an associated loss prediction if the customer purchases coverage through the connectivity hub server 105.

The agency management system 630 further provides customer data used to train the retention model 615. For example, in one embodiment, the training data includes coverage policy cancellation and renewal data, as well as underwriting and agency data for a customer, such as an associated coverage provider, policy premium, claim data, the number of drivers and vehicles in the customer's household, whether the customer has homeowner's insurance, renter's insurance, and/or monoline insurance, a garaging state of a customer vehicle, and demographic data associated with the customer, such as the customer's age and marital status. The connectivity hub server 105 uses machine learning to train the retention model 615 on the duration of customers' relationships with coverage providers and outputs, for a given customer, a resulting prediction of the life expectancy of the relationship with the coverage provider from whom the customer purchases coverage.

The connectivity hub server 105 inputs the loss prediction generated by the loss prediction model 610 and the life expectancy prediction generated by the retention model 615 to the lifetime value model 620, which computes an estimated lifetime value of a given customer. In one embodiment, the lifetime value model 620 estimates the customer value based on a loss ratio and an expected customer retention duration.

The connectivity hub server 105 further maintains, for each customer, a customer coverage table 635 that includes, for each of a plurality of coverage providers and types of coverage (e.g., auto insurance, renter's insurance, homeowner's insurance, and the like), the values calculated by the propensity to purchase model 605, the loss prediction model 610, the retention model 615, and the lifetime value model 620. In some embodiments, the values generated by the models are used to rank the carriers and to determine which coverage providers and associated coverage options to display to the customer. The connectivity hub server 105 further stores the customer coverage table 635 in a customer profile in the customer data store 245.

### Computing System Architecture

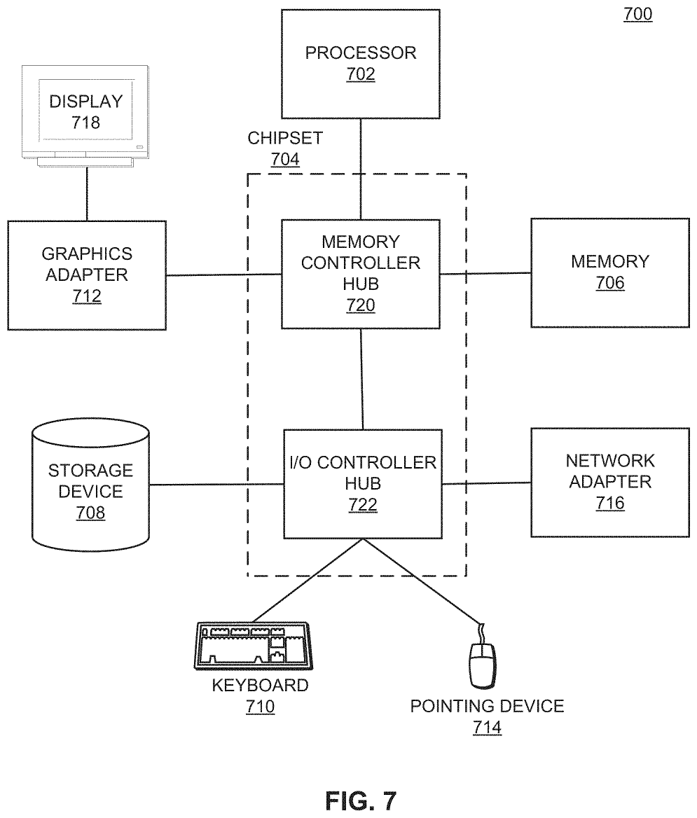

FIG. 7 is a block diagram illustrating physical components of a computer 700 used as part or all of the connectivity hub server 105, in accordance with an embodiment. Illustrated are at least one processor 702 coupled to a chipset 704. Also coupled to the chipset 704 are a memory 706, a storage device 708, a graphics adapter 712, and a network adapter 716. A display 718 is coupled to the graphics adapter 712. In one embodiment, the functionality of the chipset 704 is provided by a memory controller hub 720 and an I/O controller hub 722. In another embodiment, the memory 706 is coupled directly to the processor 702 instead of the chipset 704.

The storage device 708 is any non-transitory computer-readable storage medium, such as a hard drive, compact disk read-only memory (CD-ROM), DVD, or a solid-state memory device. The memory 706 holds instructions and data used by the processor 702. The graphics adapter 712 displays images and other information on the display 718. The network adapter 716 couples the computer 700 to a local or wide area network.

As is known in the art, a computer 700 can have different and/or other components than those shown in FIG. 7. In addition, the computer 700 can lack certain illustrated components. In one embodiment, a computer 700, such as a host or smartphone, lacks a graphics adapter 712, and/or display 718, as well as a keyboard 710 or external pointing device 714. Moreover, the storage device 708 can be local and/or remote from the computer 700 (such as embodied within a storage area network (SAN)).

As is known in the art, the computer 700 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 708, loaded into the memory 706, and executed by the processor 702.

### Additional Considerations

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments are described using the expression “coupled” and “connected” along with their derivatives. It should be understood that these terms are not intended as synonyms for each other. For example, some embodiments are described using the term “connected” to indicate that two or more elements are in direct physical or electrical contact with each other. In another example, some embodiments are described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but, in some embodiments, also includes other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for providing a connectivity hub having data-hiding features. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed. The scope of protection should be limited only by the following claims.

1. A computer-implemented method for obscuring, by a connectivity hub server, user information associated with a coverage selection process, the method comprising:
receiving, from a first user processor at a direct point of sale location, user information associated with a second user;
querying one or more third-party data sources for additional user information associated with the second user;
analyzing the additional user information received from a subset of the third-party data sources to determine whether one or more data items of the additional user information have a data sensitivity level exceeding a threshold; and
responsive to one or more data items having a data sensitivity level exceeding the threshold, providing an obscured version of the one or more data items for display on the first user processor.

2. The computer-implemented method of claim 1, further comprising:
aggregating the user information received from the first user processor and the additional user information received from the subset of the third-party data sources; and
automatically prefilling one or more fields of a coverage application using the aggregated information.

3. The computer-implemented method of claim 2, further comprising:
sending, by the connectivity hub server, the coverage application to a plurality of coverage provider processors;
receiving, at the connectivity hub server from a subset of the coverage provider processors, coverage information for available coverage options for a first type of coverage service chosen based in part on the coverage application; and
sending, from the connectivity hub server for display on a user interface of a second user processor, the coverage information for the available coverage options.

4. The computer-implemented method of claim 1, wherein the user information includes a unique identifier of the second user processor.

5. The computer-implemented method of claim 4, further comprising:
querying a second user processor, using the unique identifier, for one or more items of personally identifiable information (PII) associated with the second user;
receiving, from the second user processor, the requested one or more items of PII;
sending the one or more items of PII to a third-party data source storing unique identifying information about users and associated user processors; and
responsive to receiving an indication from the third-party data source that the one or more items of PII and the unique identifier of the second user processor match stored unique identifying information associated with the second user, verifying an identity of the second user.

6. A computer-implemented method for providing augmented reality identification of a good, the method comprising:
receiving, from a user processor, an image of a good, the image captured by a camera on the user processor and including a unique identifier of the good;
identifying one or more characteristics of the good based on the unique identifier;
querying an inventory database for inventory information of goods having the one or more identified characteristics;
responsive to identifying one or more goods having the identified characteristics, generating one or more augmented reality elements associated with the identified goods; and
providing the one or more augmented reality elements for display on the user processor.

7. The computer-implemented method of claim 6, further comprising:
receiving, from the user processor, geolocation data indicating a current location of the user processor;
determining a direct point of sale location associated with the current location;
determining, based on the inventory information, a current location of the one or more identified goods; and
filtering the one or more goods to remove goods not having a current location within a threshold distance of the direct point of sale location.

8. The computer-implemented method of claim 6, further comprising instructing the user processor to overlay the one or more augmented reality elements on a video feed captured by the camera of the user processor.

9. The computer-implemented method of claim 6, further comprising instructing the user processor to overlay the one or more augmented reality elements on the captured image.

10. The computer-implemented method of claim 6, wherein the one or more augmented reality elements include graphical or textual elements identifying the good.

11. A connectivity hub system comprising:
a first user processor configured to provide, to a connectivity hub server, user information associated with a second user;
a plurality of third-party data processors storing additional user information associated with the second user; and
the connectivity hub server comprising:
a data communications module configured to query the plurality of third-party data processors for additional information associated with the second user; and
a coverage management module configured to:
analyze the additional information received from a subset of the third-party data processors to determine whether one or more data items of the additional user information have a data sensitivity level exceeding a threshold; and
responsive to determining that one or more data items have a data sensitivity level exceeding the threshold, providing an obscured version of the one or more data items for display on the first user processor.

12. The connectivity hub system of claim 11, wherein the coverage management module provides for display on the first user processor an indication that the additional user data has been obtained from the subset of the third-party data processors.

13. The connectivity hub system of claim 11, wherein the connectivity hub server further comprises a coverage processing module configured to:
aggregate the user information received from the first user processor and the additional user information received from the subset of third-party data processors; and
automatically prefill one or more fields of a coverage application using the aggregated information.

14. The connectivity hub system of claim 13, wherein the coverage management module is further configured to:
send the coverage application to a plurality of coverage provider processors;
receive, from a subset of the plurality of coverage provider processors, coverage information for available coverage options for a first type of coverage service chosen based in part on the coverage application; and
send for display on a user interface of a second user processor, the coverage information for the available coverage options.

15. The connectivity hub system of claim 11, wherein the user information includes a unique identifier of the second user processor.

16. The connectivity hub system of claim 15, wherein the connectivity hub server further comprises an identity verification module configured to:
query a second user processor, using the unique identifier, for one or more items of personally identifiable information (PII) associated with the second user;
receive, from the second user processor, the requested one or more items of PII;
send the one or more items of PII to a third-party data source storing unique identifying information about users and associated user processors; and
responsive to receiving an indication from the third-party data source that the one or more items of PII and the unique identifier of the second user processor match stored unique identifying information associated with the second user, verify an identity of the second user.

17. The connectivity hub system of claim 14, wherein the connectivity hub server further comprises a coverage communications module configured to open a direct communication channel between the second user processor and a processor associated with a selected coverage provider.
